(19) United States
(12) Patent Application Publication
(10) Pub. No.: US 2014/0297163 A1
(43) Pub. Date: Oct. 2, 2014

(54) SYSTEM AND METHOD FOR GAS PURGE CONTROL

(71) Applicant: FORD GLOBAL TECHNOLOGIES, LLC, Dearborn, MI (US)

(72) Inventor: Niels Christopher Kragh, Commerce Township, MI (US)

(73) Assignee: Ford Global Technologies, LLC, Dearborn, MI (US)

(21) Appl. No.: 13/852,785

(22) Filed: Mar. 28, 2013

(51) Int. Cl. F02D 19/06; F02D 21/00; F02D 21/08

(52) U.S. Cl. CPC F02D 19/0642; F02D 21/08; F02D 21/00
USPC 701/108; 701/103

(57) ABSTRACT

A method for operating an engine system is provided. The method includes maintaining an intake volume positioned upstream of a throttle and downstream of air cleaner within a selected operating pressure range through adjustment of a balance purge valve positioned upstream of the intake volume and a gas discharge source.

### FIELD

The present invention relates to a method for purging gas into an intake system from a discharge gas source.

### BACKGROUND AND SUMMARY

Engines may direct a variety of gas streams to an intake system such as an evaporative emissions systems, exhaust gas recirculation (EGR) systems, and/or crankcase ventilation systems. A vacuum generated in the intake system may be used to drive gas circulation through the aforementioned systems. Valves may be employed on the aforementioned systems to control the amount of gas entering the intake system.

However, to decrease emissions and increase output engines may be operated with an intake volume downstream of a throttle approaching barometric pressure. In engine applications that operate with low vacuum air induction, or near atmospheric pressure (as measured post throttle body in the engine's intake manifold), the small amount of vacuum may not be enough to drive gas purging from the aforementioned systems (i.e., EGR systems, evaporative emissions systems, and/or crankcase ventilation systems). More particularly, in hybrid electric vehicle (HEV) applications, the engine run time may be shorter than the amount of time it takes to purge gas from the aforementioned systems with a low vacuum, such as from a fuel vapor canister.

Attempts have been made to control purging of fuel vapor through displacing an amount of intake air with fuel vapor from a canister via a diverter valve. This method relies on learning the amount of vapor flowing from the canister. This feedback process may take a considerable amount of time and may cause incorrect adjustments of the diverter valve until the vapor concentration can be determined. Furthermore, controlling the diverter valve based on vapor concentration may cause the air induction system to fluctuate and it may be difficult to precisely control canister purge valve flow.

As such in one approach, a method for operating an engine system is provided. The method includes maintaining an intake volume positioned upstream of a throttle and downstream of air cleaner within a selected operating pressure range through adjustment of a balance valve positioned upstream of the intake volume and a gas discharge source.

In this way, gas purging from the discharge gas source may be implemented based on a desired operating pressure range within the intake volume, thereby simplifying purge control when compared to systems that may calculate proportional gas flow of the purge gas and the intake air to determine valve adjustment. As such, the reliability and accuracy of purge control is improved.

In one example, the balance valve may be adjusted based on a pressure signal from a pressure sensor positioned in the intake volume, thereby enabling pressure sensor feedback to be used for purge control. In this way, feedback control may be employed to increase the reliability of the balance valve control method and decrease the likelihood of incorrect valve adjustment.

The discharge gas source may be a sealed crankcase chamber in a crankcase ventilation system, an EGR conduit in an EGR system, or a vapor canister in a vapor purge system. In this way, a feedback valve control strategy may be applied to a number of systems in the vehicle, thereby increasing the method's applicability.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows an example of a hybrid propulsion system;

FIG. 2 schematically shows an example of an engine and an associated fuel system;

FIGS. 3-5 show different examples of a system in the engine;

FIG. 6 show an example of a fuel vapor canister included in the system shown in FIG. 3; and

FIGS. 7 and 8 show an example of a method for operating an engine system.

### DETAILED DESCRIPTION

The present description relates to a method and system for operating a balance valve to maintain an intake volume within a desired operating pressure range. Different discharge gas sources such as a vapor canister in a vapor purge system, an exhaust gas recirculation (EGR) conduit in an EGR system, or a crankcase chamber in a crankcase ventilation system, may be flowed into the intake volume. The pressure in the intake volume may be maintained through a feedback control strategy which adjusts the valve based on a signal from a pressure sensor positioned in the intake volume, in one example. In this way, the amount of gas flowing through the gas discharge line does not need to be determined, if desired, thereby increasing the reliability and accuracy of the control strategy when compared to method which may adjust the valve based on a calculated flowrate of the gas and the intake air. Such an approach may enable gas purging to be completed in low vacuum air induction engine applications. Furthermore, such an approach may be applicable to hybrid electric vehicle (HEV) applications and other applications with limited engine run time.

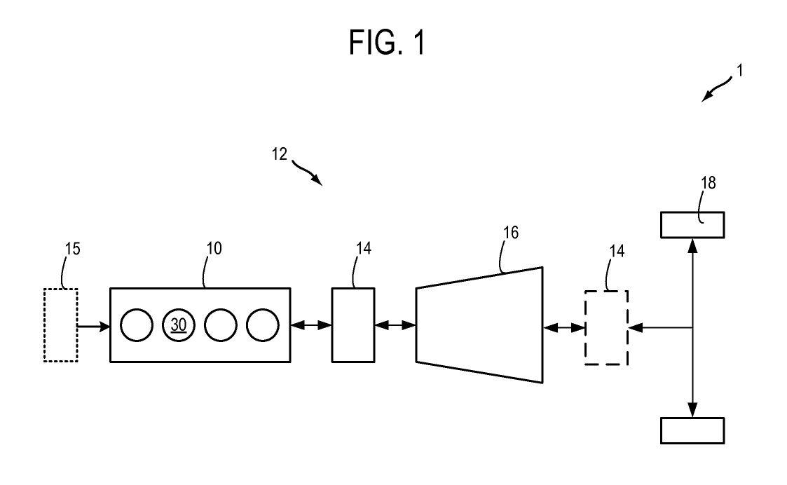

FIG. 1 schematically shows an example of a vehicle system 1 according to an embodiment of the present disclosure. The vehicle 1 includes a hybrid propulsion system 12. The hybrid propulsion system 12 includes an internal combustion engine 10 having one or more cylinders 30, a transmission 16, drive wheels 18 or other suitable device for delivering propulsive force to the ground surface, and one or more motors 14. In this way, the vehicle may be propelled by at least one of the engine or the motor. The engine may include a boosting device 15 (e.g., compressor). The boosting device may be included in a turbocharger including a turbine driven by exhaust flow, in one example.

In the illustrated example, one or more of the motors 14 may be operated to supply or absorb torque from the driveline with or without torque being provided by the engine. Accordingly, the engine 10 may operate on a limited basis. Correspondingly, there may be limited opportunity for fuel vapor purging to control evaporative emissions. It will be appreciated that the vehicle is merely one example, and still other configurations are possible. Therefore, it should be appreciated that other suitable hybrid configurations or variations thereof may be used with regards to the approaches and methods described herein. Moreover, the systems and methods described herein may be applicable to non-HEVs, such as vehicles that do not include a motor and are merely powered by an internal combustion engine.

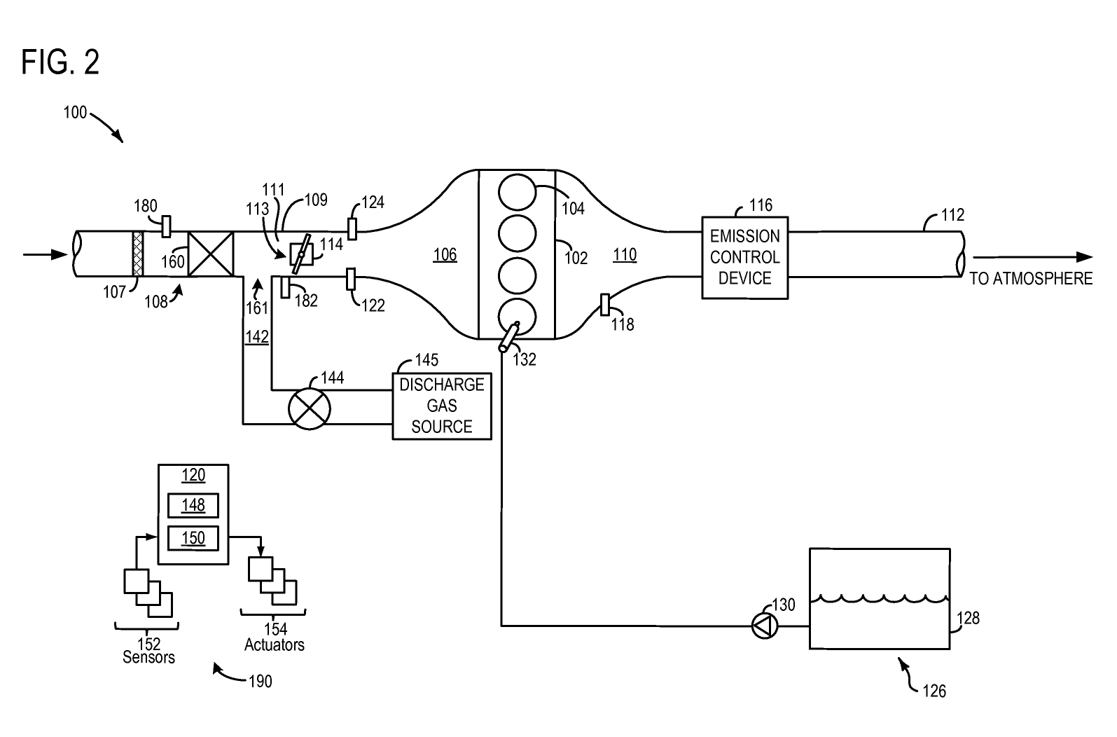

FIG. 2 schematically shows an example of an engine system 100 according to an embodiment of the present disclosure. For example, the engine system 100 may be implemented in the vehicle 1 shown in FIG. 1. It will be appreciated that a portion of the engine system 100 shown in FIG. 2 may be included in an intake system such as an air induction system (AIS) in the engine 10, shown in FIG. 1.

The engine system 100 includes an engine block 102 having a plurality of cylinders 104. The cylinders 104 may receive intake air from an intake manifold 106 via an intake passage 108 and may exhaust combustion gases to an exhaust manifold 110 and further to the atmosphere via exhaust passage 112. The intake air received in the intake passage 108 may be cleaned upon passage through an intake air cleaner 107.

A throttle 114 is positioned downstream of the air cleaner 107. The throttle 114 may be configured to alter the amount of air provided to the intake manifold 106. In this particular example, the position of the throttle 114 may be varied by a controller 120 via a signal provided to an electric motor or actuator included with the throttle 114, a configuration that is commonly referred to as electronic throttle control (ETC). In this manner, the throttle 114 may be operated to vary the intake air provided to the plurality of cylinders 104. The intake passage 108 may include a pressure sensor 124 providing a manifold air pressure (MAP) signal. A mass air flow sensor may also be positioned in the intake passage 108, in some examples. However in other examples, the mass air flow sensor may be omitted from the intake passage 108.

A mass air flow sensor 122 and a manifold air pressure sensor 124 for providing respective signals MAF and MAP to the controller 120. As further elaborated below, the intake passage may also include a balance valve 160. A portion of a housing 109 of the intake passage 108 may define an intake volume 111. The intake volume 111 is positioned downstream of the air cleaner 107 balance valve 160 and upstream of the throttle 114. Additionally, the intake volume 111 is positioned downstream of a balance valve 160 (e.g., a balance purge valve (BPV)). The balance valve may be a depression valve or a diverter valve. Thus, the balance valve 160 is positioned inline in the AIS. In one example, the intake volume 111 may include a throttle inlet 113. As shown, the balance valve 160 is positioned in the intake passage 108 upstream of an outlet 161 (e.g., gas discharge outlet) of the gas discharge line 142. Thus, the outlet 161 may open into a portion of the intake volume 111.

In some examples, the balance valve 160 may be a diverter valve. The controller 120 may be used to adjust the configuration of the balance valve 160. For example, the controller may initiate opening and closing of the balance valve. The adjustment of the balance valve 160 is discussed in greater detail herein.

The controller 120 is in electronic communication with the balance valve 160 and configured to adjust the configuration of the valve to alter the intake airflow therethrough. The controller 120 is also in electronic communication with gas discharge valve 144 and configured to adjust the configuration of the valve to alter the amount of gas flowing therethrough.

Further, for engine technologies that do not use a throttle body, the balance valve 160 may be included in the air induction system (AIS) between the air cleaner and engine intake manifold. For example, in engines configured without an intake throttle and that only operate by controlled intake valve timing (such as in Twin Independent Variable Camshaft Timing (Ti-VCT) engines), purge gas may be received between the balance valve (e.g., diverter valve) and the engine intake valves. Further still, in engines that are configured with a boosting device (such as a turbocharger or supercharger), the balance valve may be installed between the air cleaner and boosting device. Therefore in some examples, the balance valve may be positioned upstream of a boosting device (e.g., compressor), such as the boosting device 15, shown in FIG. 1.

Continuing with FIG. 2, an emission control device 116 is shown arranged along the exhaust passage 112. The emission control device 116 may be a three way catalyst (TWC), NOx trap, various other emission control devices, or combinations thereof. In some embodiments, during operation of the engine system 100, the emission control device 116 may be periodically reset by operating at least one cylinder of the engine within a particular air/fuel ratio. An exhaust gas sensor 118 is shown coupled to the exhaust passage 112 upstream of the emission control device 116. The sensor 118 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor. It will be appreciated that the engine system 100 is shown in simplified form and may include other components.

A fuel injector 132 is shown coupled directly to the cylinder 104 for injecting fuel directly therein in proportion to a pulse width of a signal received from the controller 120. In this manner, the fuel injector 132 provides what is known as direct injection of fuel into the cylinder 104. The fuel injector may be mounted in the side of the combustion chamber or in the top of the combustion chamber, for example. Fuel may be delivered to the fuel injector 132 by a fuel system 126. In some embodiments, cylinder 104 may alternatively or additionally include a fuel injector arranged in intake manifold 106 in a configuration that provides what is known as port injection of fuel into the intake port upstream of the cylinder 104.

The fuel system 126 includes a fuel tank 128 coupled to a fuel pump system 130. The fuel pump system 130 may include one or more pumps for pressurizing fuel delivered to the injectors 132 of the engine system 100, such as the fuel injector 132. While only a single injector 132 is shown, additional injectors are provided for each cylinder. It will be appreciated that fuel system 126 may be a return-less fuel system, a return fuel system, or various other types of fuel system.

The controller 120 is shown in FIG. 1 as a microcomputer, including microprocessor unit 148, input/output ports, a computer readable storage medium 150 for executable programs and calibration values (e.g., read only memory chip, random access memory, keep alive memory, etc.) and a data bus. Storage medium read-only memory 150 can be programmed with computer readable data representing instructions executable by the processor 148 for performing the methods described below as well as other variants that are anticipated but not specifically listed.

The controller 120 may receive information from a plurality of sensors 152 of the engine system 100 that correspond to measurements such as inducted mass air flow, engine coolant temperature, ambient temperature, engine speed, throttle position, manifold absolute pressure signal, intake volume pressure signal, an intake passage pressure signal, air/fuel ratio, fuel fraction of intake air, intake volume pressure, fuel tank pressure, fuel canister pressure, etc. Note that various combinations of sensors may be used to produce these and other measurements. The sensors 152 may include a pressure sensor 180 positioned upstream of the balance valve 160, a pressure sensor 182 positioned downstream of the balance valve 160 and upstream of the throttle 114 in the intake volume 111, and the pressure sensor 124.

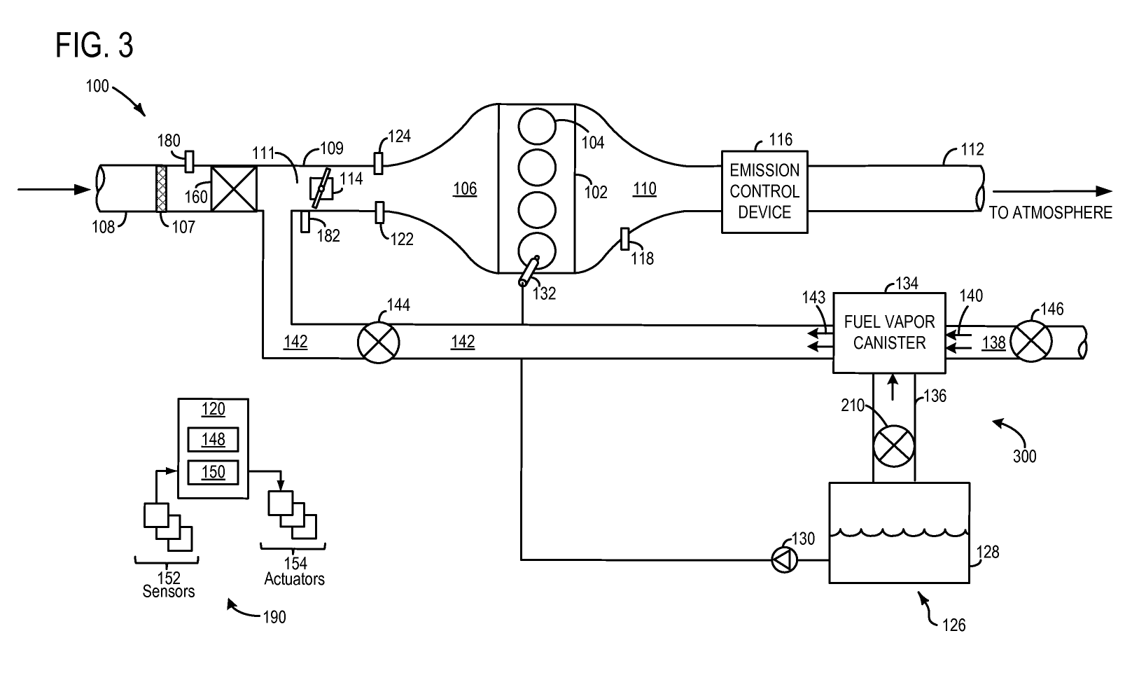

The system 100 may further include a gas discharge valve 144 positioned in the gas discharge line 142. The gas discharge valve 144 may be controlled via the controller 120. The gas discharge valve 144 may control the amount of gas flow through gas discharge line 142 from a discharge gas source 145. However, in other examples the gas discharge valve 144 may not be included in the system 100 or the gas discharge valve 144 may be integrated into the balance valve 160. The discharge gas source 145 may be a vapor canister in a vapor purge system, an EGR conduit in an EGR system, or a sealed crankcase chamber in a crankcase ventilation system. Example, discharge gas sources 145 are shown in FIGS. 3-5 and discussed in greater detail herein. Further in some examples, the gas discharge valve 144 may be positioned upstream of the discharge gas source 145.

Furthermore, the controller 120 may control a plurality of actuators 154 of the engine system 100 based on the signals from the plurality of sensors 152. Examples of actuators 154 may include the balance valve 160, the throttle 114, the fuel injector 132, and the gas discharge valve 144. In the context of a vapor purge system the gas discharge valve 144 may be a purge control valve.

The controller 120, sensor 152, actuators 154 may be included in a control sub-system 190. In one example, the controller 120 includes computer readable medium 150 having instructions that when executed by the processor 148, maintains the intake volume within a selected operating pressure range through operation of the gas discharge valve. In one example, maintaining the intake volume within the selected operating pressure range includes receiving a pressure signal from the pressure sensor at a controller and adjusting the gas discharge valve based on the pressure signal via the controller. An entirety of the selected operating pressure range is below a barometric pressure in one example. In another example, the selected operating pressure range is greater than −1.25 kilopascals (kPa).

FIGS. 3-5 show different example discharge gas sources 145 in the engine system 100. The systems shown in FIGS. 3-5 include many components which correspond to the system shown in FIG. 2. Therefore, similar parts are labeled accordingly and corresponding component descriptions may be omitted to avoid redundancy.

As shown in FIG. 3 the discharge gas source 145 is a fuel vapor canister 134 in a vapor purge system 300. Vapors generated in the fuel system 126 may be directed to an inlet of a fuel vapor canister 134 via a vapor recovery line 136. The fuel vapor canister may be filled with an appropriate adsorbent to temporarily trap fuel vapors (including vaporized hydrocarbons) during fuel tank refilling operations and “running loss” (that is, fuel vaporized during vehicle operation). In one example, the adsorbent used is activated charcoal. However, other adsorbents have been contemplated.

In examples where engine system 100 is coupled in a hybrid vehicle system, the engine may have reduced operation times due to the vehicle being powered by engine system 100 during some conditions, and by a system energy storage device or motor under other conditions. While the reduced engine operation time reduces overall carbon emissions from the vehicle, it may also lead to a decrease in purging of fuel vapors from the vehicle's emission control system. To address this, a fuel tank isolation valve 210 may be optionally included in vapor recovery line 136 such that fuel tank 128 is coupled to canister 134 via the isolation valve 210. During regular engine operation, isolation valve 210 may be kept closed to limit the amount of diurnal or “running loss” vapors directed to canister 134 from fuel tank 128. During refueling operations, and selected purging conditions, isolation valve 210 may be temporarily opened, e.g., for a duration, to direct fuel vapors from the fuel tank 128 to canister 134. By opening the valve during conditions when the fuel tank pressure is higher than a threshold (e.g., above a mechanical pressure limit of the fuel tank above which the fuel tank and other fuel system components may incur mechanical damage), the refueling vapors may be released into the canister and the fuel tank pressure may be maintained below pressure limits. While the depicted example shows isolation valve 210 positioned along vapor recovery line 136, in alternate examples, the isolation valve may be mounted on fuel tank 128.

The fuel vapor canister 134 may be fluidly coupled to a vent line 138 via a plurality of air inlets 140. In one example, one or more of the plurality of air inlets 140 may be concomitantly opened by actuating a valve 146 (e.g., common vent control valve) to fluidly couple different regions of the fuel vapor canister 134 with the vent line 138. For example, the canister may include two air vents fluidly coupled to the vent line by actuating the valve 146 (e.g., common vent control valve). In some examples, the canister may include a third air vent which is uncontrolled. Further in other examples, each of the vents may have respective vent valves that are independently controlled. Under some conditions, the vent line 138 may route gases out of the fuel vapor canister 134 to the atmosphere, such as when storing, or trapping, fuel vapors of the fuel system 126. In particular, gases may be routed out of the canister via at least one of the plurality of air inlets 140 and then through vent line 138.

The fuel vapor canister 134 may be fluidly coupled to the gas discharge line 142 via a plurality of purge ports 143. The gas discharge line 142 in the context of FIG. 3 may be referred to as a purge line.

In one example, one or more of the plurality of purge ports 143 may be concomitantly opened by actuating a gas discharge valve 144 (e.g., a common purge control valve) to fluidly couple different regions of the fuel vapor canister 134 with the purge line 142. For example, the canister may include two purge ports which may be fluidly coupled to the purge line by actuating a common purge control valve 144. In other examples, each of the purge ports may have respective valves that are independently controlled.

The vent line 138 may allow fresh air to be drawn into the fuel vapor canister 134 when purging stored fuel vapors through one or more purge ports 143 of the fuel vapor canister to the intake manifold 106 via the purge line 142. In particular, fresh air may be drawn into the canister via one or more of the plurality of air inlets 140 and purged to the intake manifold via the plurality of purge ports 143. The gas discharge valve 144 (e.g., common purge control valve) may be positioned in the purge line and may be controlled by the controller 120 to regulate flow from the fuel vapor canister to the intake manifold 106 while valve 146 (e.g., vent control valve) positioned in the vent line may be controlled by the controller 120 to regulate the flow of air and vapors between the fuel vapor canister 134 and the atmosphere. Further, the balance valve 160 may also be adjusted by the controller 120 to regulate purge flow. In some examples, the balance valve 160 may adjust purging operation and the gas discharge valve 144 may be omitted from the engine system 100, or, the gas discharge valve 144 may be integrated into a housing of the balance valve 160. To simplify or reduce hardware or number of valves, balance valve 160 may include gas discharge valve 144 and/or sensor 182. It will be appreciated that when the gas discharge valve and the balance valve are included in the same housing gas from the gas discharge valve may still be released downstream of the balance valve 160.

Further, it will be appreciated that by purging the canister to an engine intake upstream of the throttle, the vacuum requirement for canister purging is reduced. By using air that is substantially at or around atmospheric pressure conditions to purge the canister, the canister can be quickly and thoroughly purged even in low vacuum air induction engine systems and engines having shortened run time, such as with HEVs, if desired.

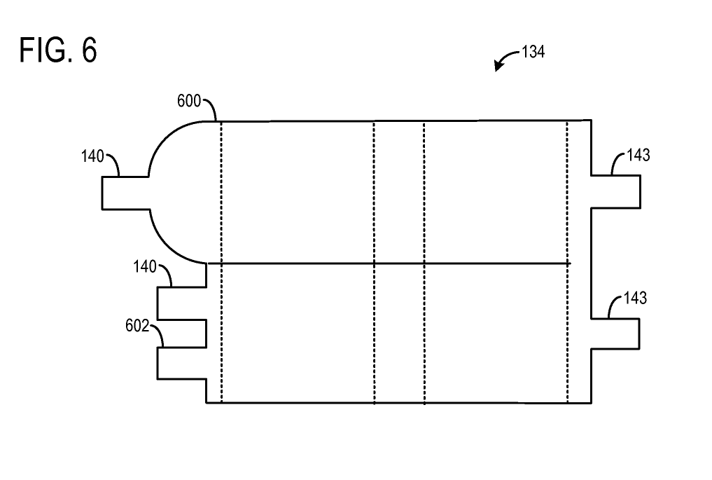

FIG. 6 shows a detailed example of the multi-port fuel vapor canister 134, shown in FIG. 3. The fuel vapor canister 134 includes a housing 600. The fuel vapor canister 134 includes two purge ports 143. However, a fuel vapor canister with an alternate number of purge ports has been contemplated. The fuel vapor canister 134 further includes two air inlets 140. The fuel vapor canister 134 also includes a vapor recovery port 602 (e.g., load port) coupled to the vapor recovery line 136, shown in FIG. 3. As shown, a portion of the housing 600 is curved around one of the air inlets 140. It will be appreciated that a variety of fuel vapor canister geometries have been contemplated. During purging of the fuel vapor canister air may enter the canister via one or more of the inlets 140 and exit the canister via one or more of the purge ports 143. Additionally, during purging fluidic communication between the fuel tank and the vapor recovery port 602 may be inhibited.

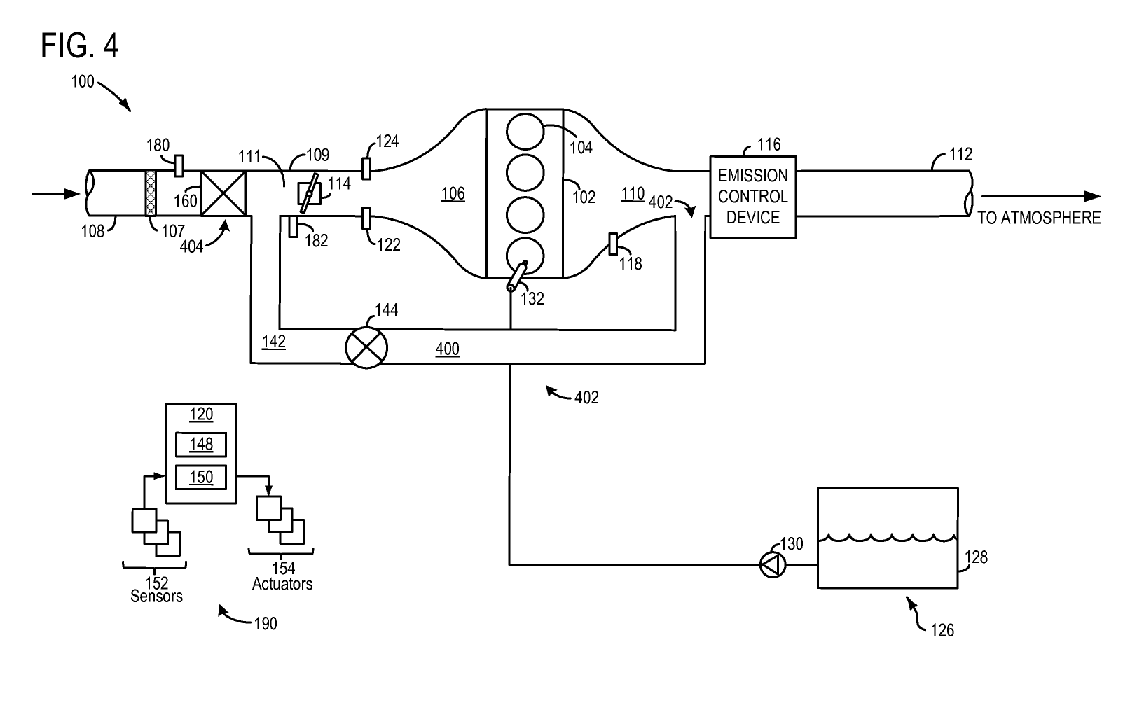

FIG. 4 shows another example system 100. The discharge gas source 145 shown in FIG. 4 is an EGR conduit 400 in an EGR system 402. The EGR conduit 400 in fluidic communication with the intake passage 108 and the exhaust manifold 110. Therefore, the EGR conduit 400 includes an inlet 402 opening into the exhaust manifold 110 and an outlet 404 opening into the AIS. In other examples, the EGR conduit may be in fluidic communication with the exhaust passage 112. It will be appreciated that other EGR system configurations have been contemplated. For example, the inlet of the EGR conduit 400 may be positioned downstream of the emission control device 166 and/or upstream or downstream of a turbine. In the example, shown in FIG. 4 the balance valve 160 and/or 144 may be referred to as EGR valves.

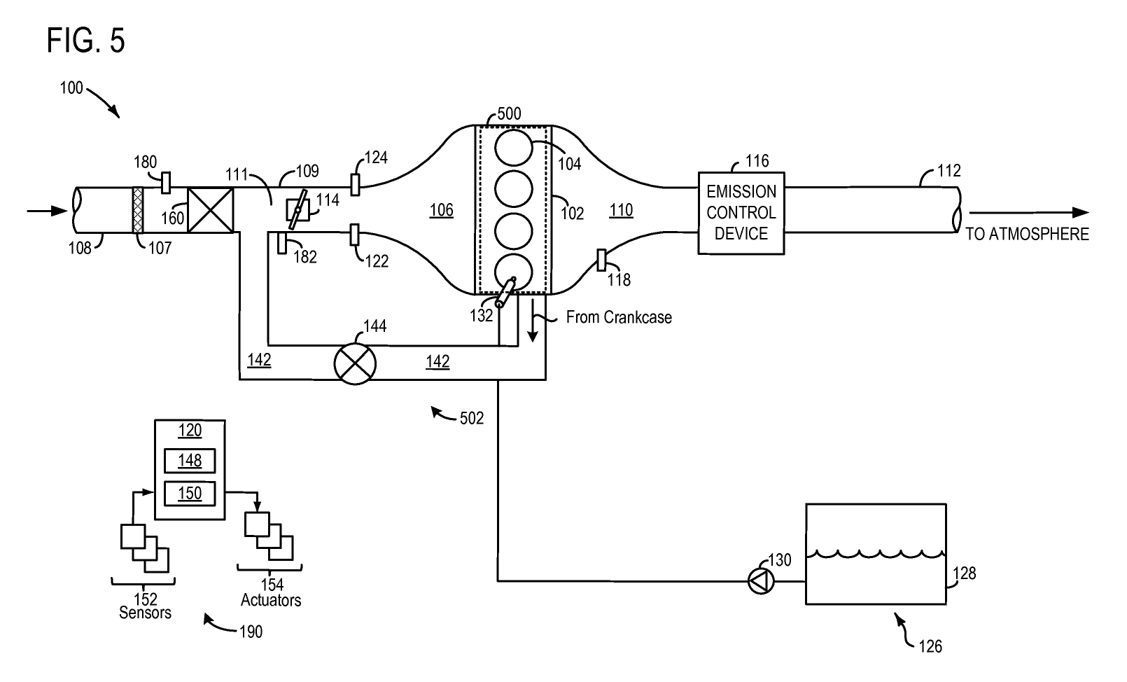

FIG. 5 shows another example system 100. The discharge gas source 145 shown in FIG. 5 is a sealed crankcase chamber 500 in a crankcase ventilation system 502. Thus, the discharge gas may be the gas from the crankcase chamber, including blow-by gasses. The gas discharge line 142 may be referred to as a crankcase ventilation line in context of the example shown in FIG. 5. The sealed crankcase chamber 500 may receive blow-by gases from the cylinders 104 and may receive fresh air from the surrounding environment. In some examples, the crankcase ventilation chamber may receive fresh intake air from a line coupled to the intake system upstream of the throttle 114 and downstream of the air cleaner 107. An oil filter (not shown) may be coupled to the inlet of the crankcase ventilation conduit 142. The oil filter may be configured to remove oil from the crankcase gases.

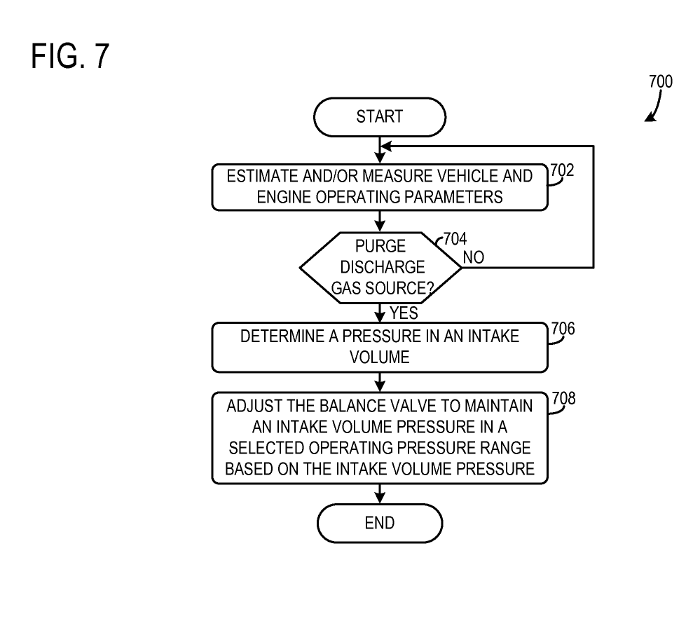

Now turning to FIG. 7, an example method 700 for operating an engine system is shown. The method 700 may be implemented via the engine, systems, and/or components discussed above with regard to FIGS. 1-6 or may be implemented via other suitable engines, systems, and/or components.

At 702 the method includes estimating and/or measuring vehicle and engine operating parameters. The operating parameters may be an engine temperature, engine output request, inlet manifold pressure, fuel injection magnitude/timing, exhaust gas composition, catalyst temperature, engine speed, engine load, canister pressure, etc.

At 704 the method determines if a discharge gas source should be purged. Purging of the discharge gas source may be determined when predetermined purge conditions are met and/or purging thresholds are met or exceeded. The discharge gas source may be a fuel vapor canister in a vapor purge system, an EGR conduit in an EGR system, or a sealed crankcase chamber in a crankcase ventilation system, as previously discussed.

If it is determined that the discharge gas source should not be purged (NO at 704) the method returns to 702. However, if it is determined that the discharge gas source should be purged (YES at 704) the method advances to 706.

At 706 the method includes determining a pressure in an intake volume. The intake volume may be positioned upstream of a throttle and downstream an air cleaner. A gas discharge outlet may open into the intake volume. Additionally, the gas discharge outlet may be in fluidic communication with a discharge gas source. The intake volume may also be positioned upstream of a boosting device, such as a compressor. Further in some examples, step 706 may include determining a pressure differential between the intake volume pressure and a pressure of an intake conduit upstream of the balance valve.

Next at 708 the method includes adjusting the balance valve to maintain an intake volume pressure in a selected operating pressure range based on the intake volume pressure. In one example, where the gas source is a fuel vapor canister the intake volume is maintained with the selected operating pressure range throughout a complete purge cycle of the canister, from commencement of vapor purging flow to stopping of purge flow. An entirety of the selected operating pressure range may be below a barometric pressure, in one example. In another example, the selected operating pressure range may be greater than −1.25 kilopascals (kPa). It will be appreciated that adjusting the balance valve may include adjusting an amount of opening and closing of the balance valve. In some examples, the pressure range in the intake volume may be maintained without determining a gas fraction (e.g., hydrocarbon fraction) from the discharge gas source. Additionally or alternatively step 708 may also include altering a configuration of the balance valve based on an algorithm or a strategy reference table stored in a controller to maintain the intake volume within a selected operating pressure range.

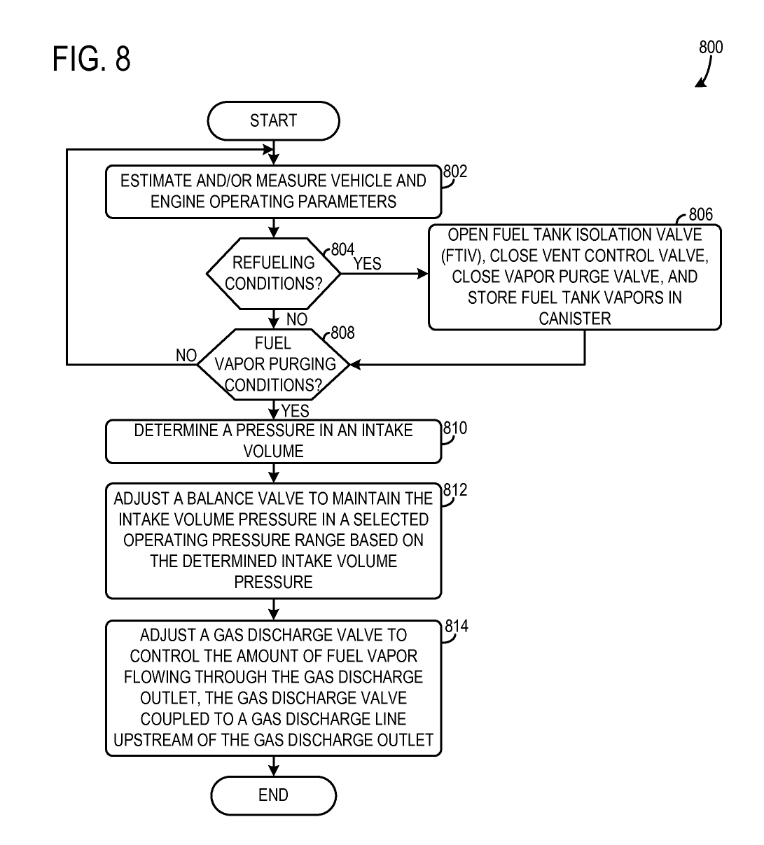

FIG. 8 shows a method 800 for operating a vapor purge system in an engine. The method 800 may be implemented via the engine, systems, and/or components discussed above with regard to FIGS. 1-6 or may be implemented via other suitable engines, systems, and/or components.

At 802 the method includes estimating and/or measuring vehicle and engine operating parameters. At 804 it is determined if refueling conditions are met. If it is determined that the refueling conditions are met (YES at 804) the method includes at 806 opening fuel tank isolation valve (FTIV), closing vent control valve, closing vapor purge valve, and storing fuel tank vapors in canister. However, if it is determined that the refueling conditions are not met (NO at 804) the method advances to 808. At 808 the method includes determining if fuel vapor purge conditions are met. If the fuel vapor purge conditions are not met (NO at 808) the method returns to 802. However, if the fuel vapor purge conditions are met (YES at 808) the method includes at 810 determining a pressure in an intake volume. The intake volume is positioned upstream of a throttle and downstream of a purge line outlet. Determining the pressure of the intake volume may include receiving a pressure signal from a pressure sensor positioned in the intake volume.

Next at 812 the method includes adjusting a balance valve to maintain an intake volume pressure in a selected operating pressure range based on the determined intake volume pressure. The balance valve may be a diverter valve positioned upstream of a throttle and downstream of an air cleaner, in one example. Additionally, a gas discharge outlet in fluidic communication with a discharge gas source may open into the intake volume. Next at 814 the method includes adjusting a gas discharge valve to control the amount of fuel vapor flowing through the gas discharge outlet, the gas discharge valve coupled to a gas discharge line upstream of the gas discharge outlet. In one example, the gas discharge valve is positioned in a gas discharge line upstream of the gas discharge outlet. In another example, the balance valve and the gas discharge valve may be integrated into a single enclosure. Further in some examples, the method may further include closing the fuel tank isolation valve after step 808.

Note that the example control routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Further, one or more of the various system configurations may be used in combination with one or more of the described diagnostic routines. The subject matter of the present disclosure includes all novel and non-obvious combinations and sub-combinations of the various systems and configurations, and other features, functions, and/or properties disclosed herein.

1. A method for operating an engine system, comprising:
maintaining an intake volume positioned upstream of a cylinder and downstream of air cleaner within a selected operating pressure range through adjustment of a balance valve positioned upstream of the intake volume and a gas discharge outlet in fluidic communication with a gas discharge source.

2. The method of claim 1, where the discharge gas source is an EGR conduit in an EGR system.

3. The method of claim 1, where the discharge gas source is a fuel vapor canister in a vapor purge system, and wherein the intake volume is maintained with the selected operating pressure range throughout a complete purge cycle of the fuel vapor canister, from commencement of vapor purging flow to stopping of purge flow.

4. The method of claim 3, further comprising adjusting a vent control valve in fluidic communication with a surrounding atmosphere and the fuel vapor canister during maintaining the intake volume within the selected operating pressure range.

5. The method of claim 1, where the discharge gas source is a sealed crankcase chamber in a crankcase ventilation system.

6. The method of claim 1, where an entirety of the selected operating pressure range is below a barometric pressure.

7. The method of claim 1, where the selected operating pressure range is greater than −1.25 kilopascals (kPa).

8. The method of claim 1, where maintaining the intake volume within a selected operating pressure range includes receiving a pressure signal from a pressure sensor positioned in the intake volume and altering a configuration of the balance valve based on the pressure signal or includes altering a configuration of the balance valve based on an algorithm or a strategy reference table stored in a controller.

9. The method of claim 1, where the gas discharge source and the intake volume are positioned upstream of the throttle.

10. The method of claim 9, where the gas discharge outlet is positioned upstream of a compressor.

11. The method of claim 1, where the intake volume includes a throttle inlet volume.

12. A method for operating a vapor purge system in an engine, comprising:
receiving a pressure signal from a pressure sensor positioned in an intake volume upstream of a throttle and downstream of an air cleaner; and
adjusting a balance purge valve positioned upstream of the throttle and a gas discharge outlet to maintain the intake volume within a selected operating pressure range based on the pressure signal.

13. The method of claim 12, further comprising adjusting a gas discharge valve to control the amount of fuel vapor flowing through the gas discharge outlet, the gas discharge valve coupled to a gas discharge line upstream of the gas discharge outlet valve to maintain the intake volume within the selected operating pressure range.

14. The method of claim 13, where the gas discharge valve is positioned downstream of a fuel vapor canister.

15. The method of claim 13, where the intake volume is positioned upstream of a compressor.

16. An engine system comprising:
an intake volume positioned upstream of a throttle;
a balance valve positioned upstream of a gas discharge outlet, the gas discharge outlet positioned upstream of the throttle; and
a control sub-system configured to:
maintain the intake volume within a selected operating pressure range through operation of the balance valve.

17. The engine system of claim 16, where the balance valve is positioned downstream of an air cleaner.

18. The engine system of claim 16, further comprising a pressure sensor positioned in the intake volume and maintaining the intake volume within the selected operating pressure range includes receiving a pressure signal from the pressure sensor at a controller and adjusting the balance valve based on the pressure signal via the controller or includes adjusting the balance valve based on an algorithm or strategy reference table with a controller.

19. The engine system of claim 16, further comprising a compressor positioned downstream of the intake volume.

20. The engine system of claim 16, where the discharge gas source is one of an exhaust gas recirculation (EGR) conduit in an EGR system, a crankcase chamber in a crankcase ventilation system, and a fuel vapor canister in a vapor purge system.
